(19) United States
(12) Patent Application Publication
(10) Pub. No.: US 2024/0110440 A1
(43) Pub. Date: Apr. 4, 2024

(54) BLIND LINE PROTECTION DEVICE

(71) Applicant: PLASTIBEC INC., Boisbriand (CA)

(72) Inventor: Benoit Meloche, Boisbriand (CA)

(21) Appl. No.: 18/334,805

(22) Filed: Jun. 14, 2023

(30) Foreign Application Priority Data
Sep. 23, 2022 (CA) 3175520

(51) Int. Cl. E06B 9/326

(52) U.S. Cl. CPC E06B 9/326

(57) ABSTRACT

A blind line protection device is provided. The blind line protection device comprises an elongated tube comprising a tubular wall and an elongated separation wall extending between opposed sides of the tubular wall and configured longitudinally within the elongated tube to divide the elongated tube into a chain-receiving compartment and a cord-receiving compartment. A pair of lips is positioned in the chain-receiving compartment, extending from opposed sides, and arranged longitudinally inside the compartment. The lips have respective distal ends arranged in a spaced-apart relation with respect to each other to define a gap allowing the insertion of the chain while preventing passage of chain beads. The blind line protection device is made as one-piece structure composed of a polymer or aluminum.

### TECHNICAL FIELD

The technical field generally relates to coverings for chains and cords for blinds used for window coverings and other architectural openings.

### BACKGROUND

Cords and chains are commonly used in various types of blinds to raise and lower blind elements and to modify the light exposure by changing the position of the blind. However, these components can represent a safety hazard in some circumstances. Some devices have been used to conceal the cord or the chain of a blind, but these known devices have drawbacks and come in two or more pieces to assemble. There is a need for technical improvements in this field.

### SUMMARY

In accordance with an aspect, there is provided a blind line protection device to enclose parts of a cord and a chain of a blind for covering an architectural opening, the device comprising an elongated tube comprising a tubular wall, an elongated separation wall extending between opposed sides of the tubular wall and configured longitudinally within the elongated tube to divide the elongated tube into a chain-receiving compartment and a cord-receiving compartment; and a pair of lips positioned in the chain-receiving compartment and extending from opposed sides thereof and arranged longitudinally therein, the lips having respective distal ends arranged in spaced-apart relation with respect to each other to define a gap therebetween to allow insertion of the chain while preventing passage of chain beads.

In some implementations, the device is formed as a one-piece structure that is composed of a polymer or aluminum.

In some implementations, the polymer is polyvinyl chloride (PVC).

In some implementations, the device is made by extrusion.

In some implementations, the lips are disposed in a perpendicular manner with respect to the elongated separation wall.

In some implementation, the lips are centered with respect to the elongated separation wall and aligned with one another.

In some implementations, the lips are smaller than the distance between two beads.

In some implementations, the gap is sized to prevent chain beads from passing therethrough.

In some implementations the gap is sized to receive a preassemble looped chain.

In some implementations, the elongated separation wall is provided in a middle of the elongated tube.

In some implementations, the tubular wall comprises four side walls.

In some implementations, the four side walls comprise front and back walls that are flat and opposed lateral walls that are convexly curved.

In some implementations, the front and back walls are longer than the opposed lateral walls such that the elongated tube has a flattened shape.

In some implementations, the elongated separation wall extends from one lateral wall to the other.

In some implementations, the lips, the elongated separation wall and the tubular wall have a same thickness.

In some implementations, the distal end of each of the lips has a rectilinear shape in cross-section.

In some implementations, each of the lips has a same depth projecting into the chain-receiving compartment.

In some implementations, the lips, the elongated separation wall and the tubular wall have a wall thickness between 0.03 and 0.05 inch, the elongated tube has a width between 1.5 and 1.8 inches and a depth between 0.4 and 0.7 inch, the elongated tube has a width to depth ratio between 2.1 and 4.5, the gap is between 0.09 and 0.12 inch, the chain-receiving compartment has a depth between 0.15 and 0.25 inch, the cord-receiving compartment has a depth between 0.15 and 0.25 inches, and/or the lips each have a depth of 0.08 to 0.13 inch.

In some implementations, the gap is larger than the depth of each of the lips.

In some implementations, the device has a length in operation that encloses the chain and the cord while leaving 0.4 to 8.7 inches thereof accessible to a user.

In some implementations, the front and back walls are of equal length, and the opposed lateral walls are of equal length and curvature.

In some implementations, the device comprises an extruded core and an outer coating.

In some implementations, the chain-receiving compartment and the cord-receiving compartment are the only enclosed compartments in cross-section.

### BRIEF DESCRIPTION OF THE DRAWINGS

The attached figures illustrate various features, aspects and implementations of the technology described herein.

FIG. 1 is a cross-sectional view of an example blind line protection device.

FIG. 2 is a side view of the example blind line protection device.

FIGS. 3A to 3C are close-up schematics of part of the lips of the device and part of a chain having beads and cordage inserted through the gap defined between the lips.

### DETAILED DESCRIPTION

Various elements of a cord and a chain protection device, which can be general referred to herein as a chain tube or a blind line protection device, are described in the present description. The device is configured for covering the cord and chain of a blind to enhance safety while facilitating assembly and operation of the blind. It is noted that the device can be used to enclose a cord only, a chain only, or both a chain and a cord of the blind which can be used for covering any architectural opening, such as windows or doors. Both cords and chains are generally referred to herein as “blind lines”. The device can be generally viewed as an elongated tube containing two elongated compartments that can respectively receive a chain and a cord. The two compartments can be referred as a chain-receiving compartment and a cord-receiving compartment, respectively. The chain-receiving compartment can include a pair of lips which can be positioned to extend from opposed sides to prevent the chain from twisting. The lips can also be spaced-apart to define a gap that can be useful for inserting preassembled loop chains inside the device while preventing the chain beads from passing through the gap.

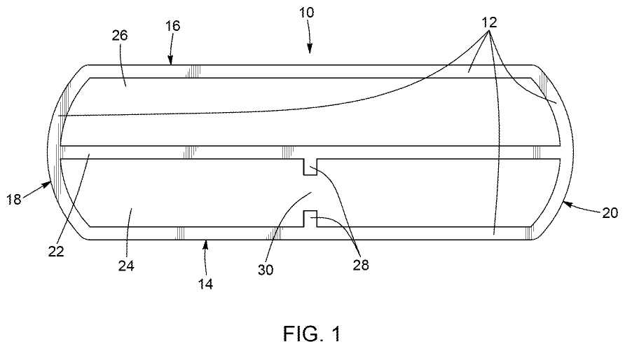

Referring to FIG. 1, a blind line protection device includes an elongated tube 10 comprising a tubular wall 12. The tubular wall 12 includes a front wall 14, a back wall 16 and lateral walls 18 and 20, which have outer surfaces that are visible to the user. An elongated separation wall 22 extends between opposed sides of the tubular wall 12 within the cavity of the elongated tube 10. This elongated separation wall 22 forms two compartments: a chain-receiving compartment 24 and a cord-receiving compartment 26. In the chain-receiving compartment 24, a pair of lips 28 can be positioned to prevent the chain from twisting in that compartment. These lips 28 can extend from opposed sides, can be arranged longitudinally to the chain-receiving compartment 24, and can be sized to create a gap 30 between them.

### Elongated Tube Implementations

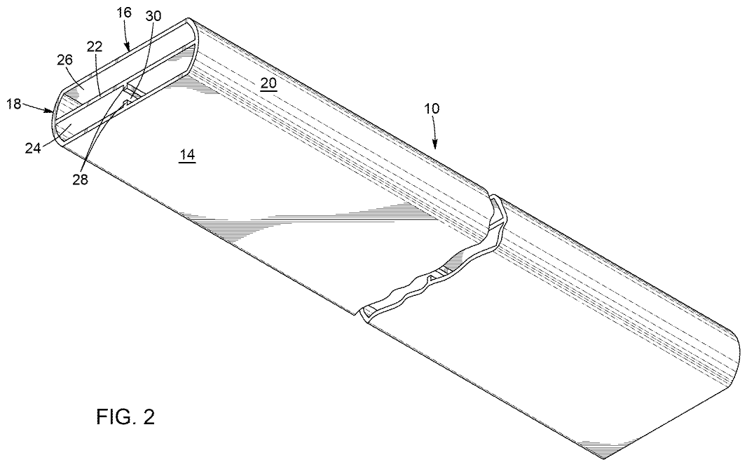

Referring to FIG. 2, the elongated tube 10 can be extruded as a one-piece structure made of polymer or made of aluminum or another material. The elongated tube 10 is preferably composed of an extruded material. The elongated tube 10 can be made of clear or colored polyvinyl chloride (PVC), for example. In other implementations, any other suitable polymer or material may be used.

Referring again to FIG. 1, as mentioned previously, the tubular wall 12 can include four side walls: the front wall 14, the back wall 16 and the opposed lateral walls 18 and 20. The back wall 16 and the front wall 14 can be flat and the opposed lateral walls 18 and 20 can be convexly curved. In other implementations, the opposed lateral walls 18 and 20 may be concave, straight, curved or angled in other ways.

In addition, the front wall 14 and the back wall 16 can be longer than the opposed lateral walls 18 and 20, conferring to the elongated tube 10 a flattened shape. In this implementation, the front wall 14 and the back wall 16 are of equal length, as are the opposed lateral walls 18 and 20 in addition to being of the same curvature. The device can be symmetrical about one axis, although alternatively it could be asymmetrical.

In this implementation, the elongated separation wall 22 is positioned in the middle of the elongated tube 10 to define the two compartments. In other scenarios, the elongated separation wall 22 could be positioned in such ways that the chain-receiving compartment 24 and the cord-receiving compartment 26 are different sizes and/or shapes. The elongated separation wall 22 can be parallel with the front wall 14 and the back wall 16 or angled or arranged in various other ways.

To form the chain-receiving compartment 24 and the cord-receiving compartment 26, the elongated separation wall 22 can extend from one lateral wall 18,20 to the other such that the compartments are fully separated. In some implementations, the chain-receiving compartment 24 and the cord-receiving compartment 26 are the only enclosed compartments in cross-section, although it is also possible to provide additional structures in the tube to define other compartments if desired.

In this implementation, the lips 28 are disposed in the chain-receiving compartment 24, but in other scenarios, lips 28 could be disposed in both the chain-receiving compartment 24 and the cord-receiving compartment 26.

### Chain-Receiving Tube Implementations

Still referring to FIG. 1, the pair of lips 28 can be disposed perpendicularly and centered with respect to the elongated separation wall 22. The lips 28 can also align with one another such that they are co-planar. Alternatively, the lips 28 could be arranged in other ways, such as being offset and/or positioned in other regions of the chain-receiving compartment 24.

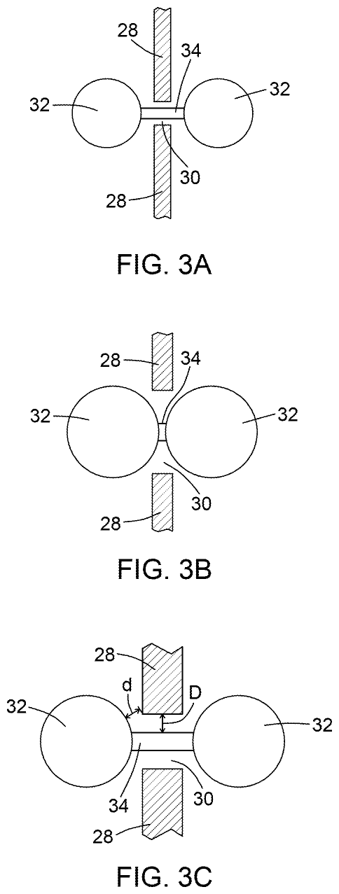

To insert preassembled chain loops inside the chain-receiving compartment 24, the lips 28 should spaced apart so that the gap 30 is larger than the thickness between two beads 32 of the chain. In other words, the gap 30 is large enough so that the chain can be inserted through the gap at the region of the chain defined in between two adjacent beads 32. The gap 30 size can thus depend on various factors regarding the chain, such as bead 32 size and shape, bead 32 spacing, and cordage 34 diameter. If the beads 32 are far apart (e.g., see FIG. 3A), then the gap 30 could be sized based on the cordage 34 exposed in between adjacent beads 32 so be at least slightly larger than the cordage 34 diameter. If the beads 32 are quite close together (e.g., see FIG. 3B), then the gap 30 could be sized based on the bead 32 size. FIG. 3C shows how the spacing between the lips 28 and the chain components can have different factors, including a distance (d) between the lip 28 and each adjacent bead 32 and the distance (D) between the lip 28 and the cordage 34. In some implementations, both (d) and (D) are sufficient to provide desired play between the chain and the lips 28, e.g., each of (d) and (D) are at least 0.5 mm.

Referring back to FIG. 2, the lips 28 can have the same depth projecting into the chain-receiving compartment 24 and can thus be of the same size. As noted above, the gap 30 is sized to be wider than the distance between two beads 32 but smaller than the diameter of the smallest chain beads commonly used in the industry, which is, at this time, 0.125 inch in diameter. Therefore, the gap 30 can be used to both facilitate the insertion of a preassemble chain loop inside the chain-receiving compartment 24 and to prevent chain beads from passing therethrough and leading to tangling between opposed lengths of the chain that make up the loop.

In the illustrated implementation, the lips 28 present a rectilinear shape in cross-section. In other scenarios, the lips 28 could have rounded edges or any other suitable shape.

### Possible Dimensions for Optional Implementations

The following section describes different dimensions that are possible for the elements previously presented. FIG. 1 is used as a reference for this section.

Regarding the thickness of the blind line protection device, the lips 28, the elongated separation wall 22 and the tubular wall 12 can have the same thickness. This thickness can be between 0.003 inch and 0.05 inch.

For the dimensions of the elongated tube 10, its width can range between 1.5 and 1.8 inches and its depth, between 0.4 and 0.7 inch conferring to it the flattened shape mentioned above. Therefore, the elongated tube's 10 width to depth ratio can range between 2.1 and 4.5.

Turning to the compartments, both the chain-receiving compartment 24 and the cord-receiving compartment 26 can present depths ranging from 0.15 to 0.25 inch. In this implementation, the depths of the chain-receiving compartment 24 and the cord-receiving compartment 26 are the same.

Focusing to the chain-receiving compartment 24 in particular, the size of the gap 30 can be between 0.09 and 0.12 inch and the depth of each lip 28 ranging between 0.08 and 0.13 inch. In this implementation, the gap 30 is larger than the depth of one lip 28.

### Fabrication, Use and Installation

The blind line protection device is preferably extruded and is composed of an extruded core made of polymer or aluminum and an outer coating that can be smooth. An extrusion process is thus used to produce the device in this implementation. The coating is optional and can be applied using various techniques, such as application using rollers, dip coating, or other methods.

The combination of a cord and one chain is used to describe the following aspects of the device regarding its use and its installation. It should be noted that a chain alone or a cord alone could be found in the mechanism of a blind. The references used are from FIG. 1.

The main use of the blind line protection device is to conceal parts of the chain and the cord of a blind so that most of their length is inaccessible. The maximum chain or cord exposure for the user should be less than 8 inches, though other exposure lengths are possible. Depending on the configuration of the blind, the exposed length may be between 0.5 and 8 inches, for example. The maximum exposed length can also be selected based on existing or applicable regulations regarding safety of blind cords and chains. The total length of the elongated tube 10 should be chosen accordingly. The elongated tube 10 can be extruded to any length and then cut to different lengths to the manufacturer's or installer's specifications, on site or off site, depending on the configurations and dimensions of the blinds.

Concerning the installation of the blind line protection device, the chain is often already connected to the blind's mechanism but the cord, on the other hand, is usually not. The chain is first inserted into the elongated tube 10 using the gap 30 in the chain-receiving compartment 24 so that one string of the chain is on one side of the gap 30 and one string is on the other. To insert the cord into the cord-receiving compartment 26, the cord is looped at the bottom of the elongated tube 10 and threated back to the top where the cord will be attached to the appropriate blind mechanism. The loops (the expression “loops” refers to both chain loop and cord loop) hanging at the bottom of the elongated tube 10 can be inserted into a hold down bracket screwed to a wall panel (the expression “wall panel” refers to an infrastructural wall near the architectural opening where the blind would be positioned). This bracket is preferably structured as a locking device that locks the cord and the chain to make it impossible to freely operate the chain or the cord without it being screwed to the wall panel. The bracket also ensures that the loops remain in the device. To move either the cord or the chain, the user would have to lift or slide the elongated tube 10 up to reveal a lower part of the cord and the chain.

Several alternative implementations and examples have been described and illustrated herein. The implementations of the technology described above are intended to be exemplary only. The implementations could be provided in any combination with the other implementations disclosed herein. It is understood that the technology may be embodied in other specific forms without departing from the central characteristics thereof. The present implementations and examples, therefore, are to be considered in all respects as illustrative and not restrictive, and the technology is not to be limited to the details given herein. Accordingly, while the specific implementations have been illustrated and described, numerous modifications come to mind.

1. A blind line protection device to enclose parts of a cord and a chain of a blind for covering an architectural opening, the device comprising:
an elongated tube comprising a tubular wall;
an elongated separation wall extending between opposed sides of the tubular wall and configured longitudinally within the elongated tube to divide the elongated tube into a chain-receiving compartment and a cord-receiving compartment; and
a pair of lips positioned in the chain-receiving compartment and extending from opposed sides thereof and arranged longitudinally therein, the lips having respective distal ends arranged in spaced-apart relation with respect to each other to define a gap therebetween to allow insertion of the chain while preventing passage of chain beads.

2. The blind line protection device of claim 1, wherein the device is formed as a one-piece structure that is composed of a polymer or aluminum.

3. The blind line protection device of claim 2, wherein the polymer is polyvinyl chloride (PVC).

4. The blind line protection device of claim 2, wherein the device is made by extrusion.

5. The blind line protection device of claim 1, wherein the lips are disposed in a perpendicular manner with respect to the elongated separation wall.

6. The blind line protection device of claim 5, wherein the lips are centered with respect to the elongated separation wall and aligned with one another.

7. The blind line protection device of claim 6, wherein a wall thickness of the lips is smaller than a distance between two chain beads.

8. The blind line protection device of claim 1, wherein the gap is sized to receive a preassemble looped chain.

9. The blind line protection device of claim 1, wherein the elongated separation wall is provided in a middle of the elongated tube.

10. The blind line protection device of claim 1, wherein the tubular wall comprises four side walls.

11. The blind line protection device of claim 10, wherein the four side walls comprise front and back walls that are flat and opposed lateral walls that are convexly curved.

12. The blind line protection device of claim 11, wherein the front and back walls are longer than the opposed lateral walls such that the elongated tube has a flattened shape.

13. The blind line protection device of claim 11, wherein the elongated separation wall extends from one lateral wall to the other.

14. The blind line protection device of claim 1, wherein the lips, the elongated separation wall and the tubular wall have a same thickness.

15. The blind line protection device of claim 1, wherein:
the lips, the elongated separation wall and the tubular wall have a wall thickness between 0.03 and 0.05 inch;
the elongated tube has a width between 1.5 and 1.8 inches and a depth between 0.4 and 0.7 inch;
the elongated tube has a width to depth ratio between 2.1 and 4.5;
the gap is between 0.09 and 0.12 inch;
the chain-receiving compartment has a depth between 0.15 and 0.25 inch;
the cord-receiving compartment has a depth between 0.15 and 0.25 inches; and/or
the lips each have a depth of 0.08 to 0.13 inch.

16. The blind line protection device of claim 15, wherein the gap is larger than the depth of each of the lips.

17. The blind line protection device of claim 1, wherein the device has a length in operation that encloses the chain and the cord while leaving 0.4 to 8.7 inches thereof accessible to a user.

18. The blind line protection device of claim 12, wherein the front and back walls are of equal length, and the opposed lateral walls are of equal length and curvature.

19. A blind line protection device comprising:
an elongated tube comprising a tubular wall and being extruded;
an elongated separation wall extending between opposed sides of the tubular wall and configured longitudinally within the elongated tube to divide the elongated tube into a first compartment and a second compartment; and
a pair of lips positioned in the first compartment and extending from opposed sides thereof and arranged longitudinally therein, the lips having respective distal ends arranged in spaced-apart relation with respect to each other to define a gap therebetween and adjacent chambers, the chambers having a size accommodating a chain comprising chain beads and cordage and the gap having a size allowing passage of the cordage while preventing passage of chain beads.

20. A method of covering a cord and a chain used for a blind using the device as defined in claim 1, the method comprising inserting the cord into the cord-receiving compartment and inserting the chain into chain-receiving compartment by passing cordage of the chain through the gap such that opposed sections of the chain are within opposed chambers of the chain-receiving compartment separated by the lips.
